(19) United States
(12) Patent Application Publication
(10) Pub. No.: US 2006/0153526 A1
(43) Pub. Date: Jul. 13, 2006

(54) Portable electronic apparatus and recording control method therefor

(75) Inventor: Takuji Kimura, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/200,083

(22) Filed: Aug. 10, 2005

(30) Foreign Application Priority Data
Dec. 27, 2004 (JP) 2004-378145

(51) Int. Cl. H04N 5/91

(52) U.S. Cl. 386/83

(57) ABSTRACT

In a portable electronic apparatus of the present invention, when a timer unit measures a video recording permission/inhibition determination time, in order to determine the reception condition of the reservation program stored in a memory unit, a CPU/control unit obtains the determination signal from a tuner unit and a demodulation unit to perform a video recording permission/inhibition determination process. If it is determined that the reception condition is a reservation video recording disable condition, the user who has performed reservation video recording is notified of the condition. By this notification, the user can take countermeasures for improving the reception condition until a video recording start time, or requesting a substitute device to execute the video recording process, before the reservation video recording start time.

### CROSS-REFERENCE TO RELATED APPLICATIONS

This application is based upon and claims the benefit of priority from prior Japanese Patent Application No. 2004-378145, filed Dec. 27, 2004, the entire contents of which are incorporated herein by reference.

### BACKGROUND OF THE INVENTION

1. Field of the Invention

The present invention relates to a portable electronic apparatus which has a function of receiving and recording a broadcast program such as a television broadcast, radio broadcast, or the like, and a reservation video recording function preferably applied to a cellular phone, portable terminal, mobile terminal, or the like, and a recording control method therefor.

2. Description of the Related Art

Recently, various types of portable radio communication apparatuses using a mobile computing technique have been developed. For example, as a portable device and mobile terminal such as a cellular phone and portable terminal disclosed in Jpn. Pat. Appln. KOKAI Publication No. 2004-15333, a device having an Internet connection function and a function of receiving an analog terrestrial broadcast signal has been put into practical use. Also, a device having a function of receiving a digital terrestrial broadcast signal, mobile broadcast signal, and the like has been developed.

Digital terrestrial broadcasting employs a scheme suited to mobile reception or portable reception. Generally, in comparison with an analog terrestrial broadcast signal, the digital terrestrial broadcast signal can be stably received without being influenced by a reception environmental change caused by movement of the apparatus.

However, when a reception condition becomes worse, a digital broadcast is set in a reception enable condition or reception disable condition, unlike an intermediate reception condition of an analog broadcast, i.e., “the contents can be partially obtained, but it is difficult to recognize them completely”.

That is, when a digital broadcast is set in the reception disable condition, it is meaningless to continuously video-record a reserved program. For example, in the portable device, a battery capacity is wasted.

In this type of portable device, when the reception condition becomes worse during video recording, a user is notified of the worse reception condition. Accordingly, the problem that the reserved program is continuously video-recorded in the above-described reception disable condition can be solved.

However, when performing the video recording process by using the reservation video recording function, the user knows that the reception condition became worse, after video recording is started. Accordingly, the reserved program cannot be video-recorded, and a reliable reservation video recording function cannot be implemented. As described above, conventionally, the reliable reservation video recording function cannot be implemented in the portable electronic apparatus such as the portable device or mobile terminal, thus posing a problem.

### BRIEF SUMMARY OF THE INVENTION

According to an embodiment of the present invention, a portable electronic apparatus comprises a reception unit configured to receive a broadcast program, a recording unit configured to record contents of the broadcast program received by the reception unit, a time setting unit configured to set a recording start time and a recording permission/inhibition determination time for recording the contents of the broadcast program received by the reception unit, on the recording unit, a holding unit configured to hold time information indicating the recording start time and the recording permission/inhibition determination time set by the time setting unit, a time measurement unit configured to measure time in accordance with the time information held by the holding unit, and a recording control unit configured to check, when the time measurement unit measures the recording permission/inhibition determination time held by the holding unit, a reception condition of the reception unit, notify, when the reception unit is not set in a predetermined reception level condition in which the broadcast program is configured to be received, an external unit of the reception level condition, and record, when the reception unit is set in the predetermined reception level condition in which the broadcast program is configured to be received, the contents of the broadcast program received by the reception unit on the recording unit, after the time measurement unit measures the recording start time held by the holding unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of a portable electronic apparatus according to the first and second embodiments of the present invention;

FIG. 2A is an operation timing chart showing a reservation video recording process in the portable electronic apparatus and, particularly, showing an example of a time measurement start timing, according to the first embodiment of the present invention;

FIG. 2B an operation timing chart showing a reservation video recording process in the portable electronic apparatus and, particularly, showing an example of a video recording permission/inhibition determination processing timing, according to the first embodiment of the present invention;

FIG. 2C an operation timing chart showing a reservation video recording process in the portable electronic apparatus and, particularly, showing an example of a video recording start timing, according to the first embodiment of the present invention;

FIG. 2D an operation timing chart showing a reservation video recording process in the portable electronic apparatus and, particularly, showing an example of a notification processing timing in a reservation video recording disable condition, according to the first embodiment of the present invention;

FIG. 3 is a flowchart showing an example of the processing sequence of the reservation video recording process in the portable electronic apparatus according to the first embodiment of the present invention;

FIG. 4 is a flowchart showing an example of the processing sequence of the reservation video recording process in the portable electronic apparatus according to the first embodiment of the present invention;

FIG. 5 is a flowchart showing an example of the processing sequence of the reservation video recording process in the portable electronic apparatus according to the second embodiment of the present invention; and

FIG. 6 is a block diagram showing the arrangement of a portable electronic apparatus according to the third embodiment of the present invention.

### DETAILED DESCRIPTION OF THE INVENTION

Embodiments of the present invention will be described below with reference to the accompanying drawing.

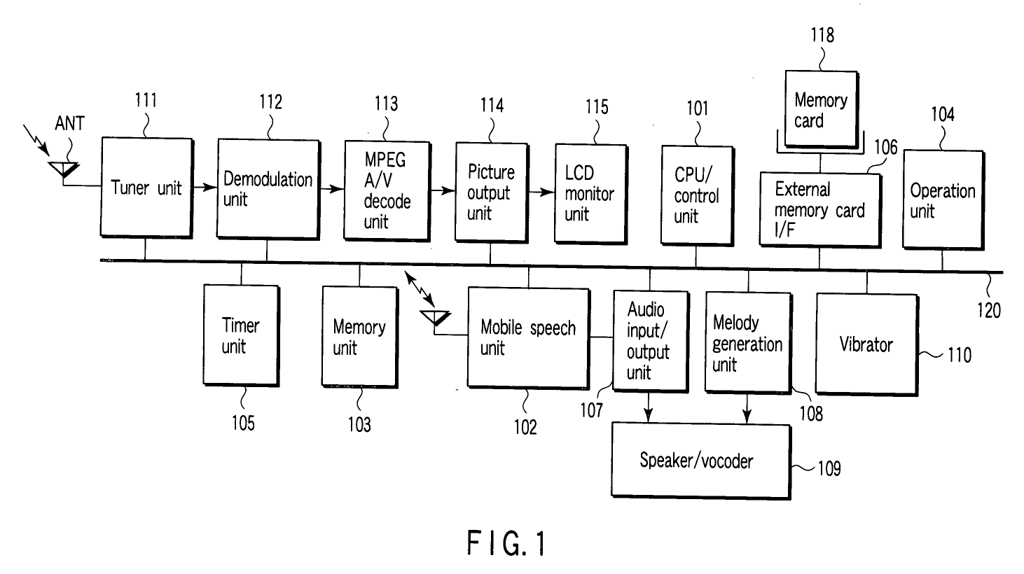

The arrangement of a portable electronic apparatus according to the first and second embodiments of the present invention is shown in FIG. 1. In these embodiments, the arrangement of a cellular phone set having a function of receiving and video-recording a digital television broadcast signal is exemplified.

The portable electronic apparatus according to the first and second embodiments of the present invention includes a CPU/control unit 101, mobile speech unit 102, memory unit 103, operation unit 104, timer unit 105, external memory card interface 106, tuner unit 111, demodulation unit 112, MPEG A/V decode unit 113, picture output unit 114, LCD monitor unit 115, audio input/output unit 107, melody generation unit 108, speaker/vocoder 109, vibrator 110, memory card 118, and the like. These elements except the speaker/vocoder 109 and the memory card 118 are connected to each other through a system bus 120.

The CPU/control unit 101, memory unit 103, operation unit 104, and timer unit 105 are elements for inputting and controlling data in an entire system. The tuner unit 111, demodulation unit 112, MPEG A/V decode unit 113, picture output unit 114, LCD monitor unit 115, external memory card interface 106, and memory card 118 are elements for mainly receiving and video-recording/playing back the digital television broadcast signal. The mobile speech unit 102, audio input/output unit 107, melody generation unit 108, speaker/vocoder 109, and vibrator 110 are elements for mainly implementing the function of the cellular phone.

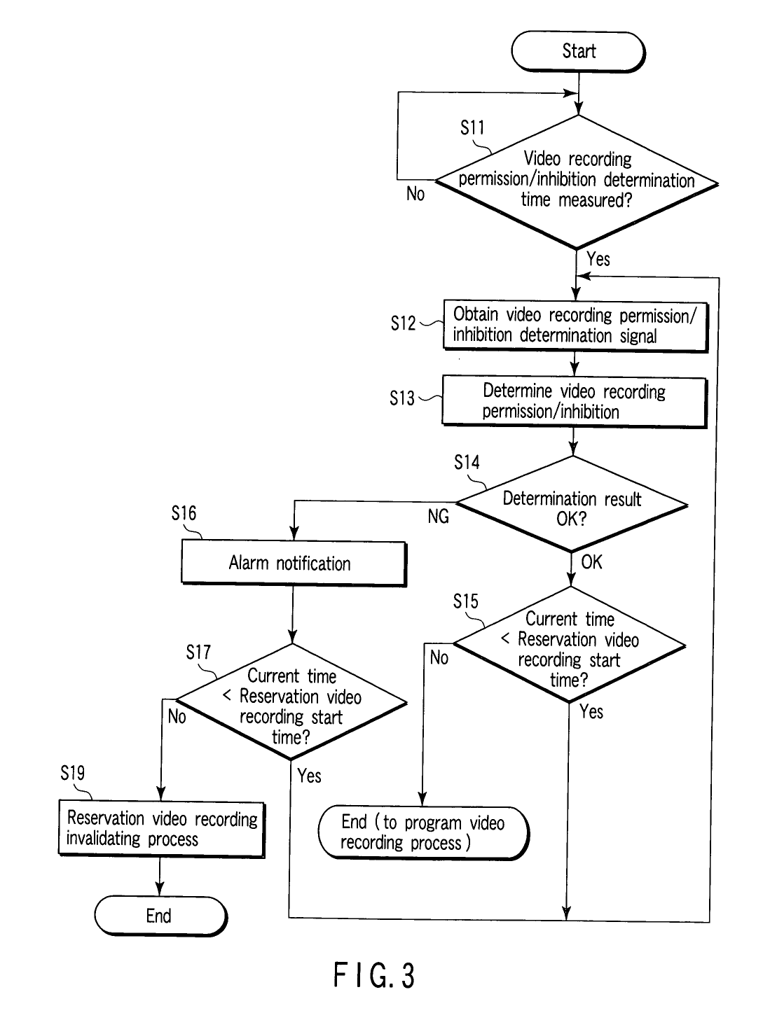

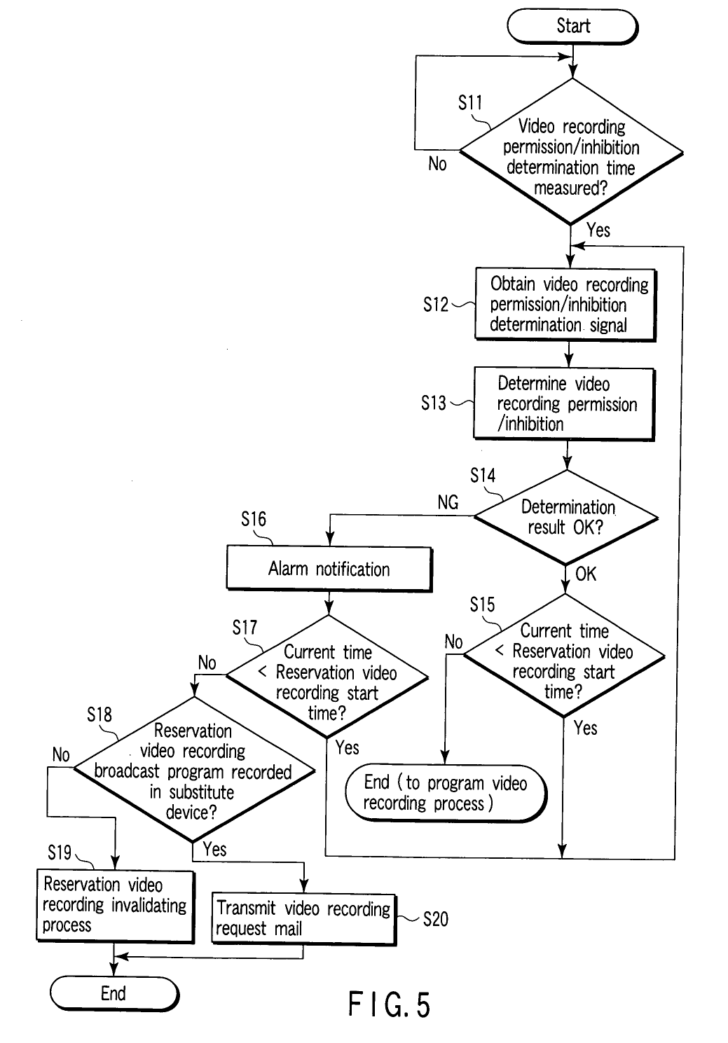

The CPU/control unit 101 which controls the entire system executes various processes in accordance with programs stored in the memory unit 103, upon receiving input instructions from the operation unit 104. In the first and second embodiments, in a reservation video recording process, the reservation video recording process shown in FIGS. 3 and 4 is executed in the first embodiment, and the reservation video recording process shown in FIG. 5 is executed in the second embodiment.

The memory unit 103 stores various programs, operation data, and the like executed by the CPU/control unit 101. In the reservation video recording process, the memory unit 103 stores the data of a broadcast program (broadcasting station) and its reservation video recording start time, and the data of video recording permission/inhibition determination time for determining permission/inhibition of the above-described reservation video recording process in accordance with the reception condition of the tuner unit 111. These data are set by the operation unit 104 under the control of the CPU/control unit 101, and stored in association with each other. Note that in the first and second embodiments, the user can arbitrarily set the above-described video recording permission/inhibition determination time. However, the video recording permission/inhibition determination time can also be set in the process of the CPU/control unit 101. In this case, the operation unit 104 need not set the video recording permission/inhibition determination time. The operation unit 104 can select the mode that sets the above-described video recording permission/inhibition determination time by the user, or the mode that determines and sets the above-described video recording permission/inhibition determination time by the device.

The operation unit 104 has various keys and switches operated by the user. The CPU/control unit 101 is notified of commands accompanying their operations. In the reservation video recording process according to the embodiments of the present invention, the operation unit 104 comprises an operation input means for inputting the data of the broadcast program (broadcasting station or broadcast channel) and its reservation video recording start time, and the data of the video recording permission/inhibition determination time at which permission/inhibition of the reservation video recording process is determined in accordance with the reception condition of the tuner unit 111. This operation input means may be implemented only by the operation unit 104, or implemented on a display by cooperation of the operation unit 104 and the LCD monitor unit 115.

The timer unit 105 executes various timer count processes under the control of the CPU/control unit 101. The CPU/control unit 101 is notified of this count condition. In the reservation video recording process according to the embodiments of the present invention, under the control of the CPU/control unit 101, the timer unit 105 measures the video recording permission/inhibition determination time for determining permission/inhibition of the reservation video recording process, and the reservation video recording start time which are stored in the memory unit 103.

The external memory card interface 106 has a card slot and card connection interface which allow to insert/remove the memory card 118. Under the control of the CPU/control unit 101, the memory card 118 mounted in the card slot records data. The recorded data is read out and output to the system bus 120. In the reservation video recording process according to the embodiments of the present invention, under the control of the CPU/control unit 101, the external memory card interface 106 records content data of the broadcast program received by the tuner unit 111. The recorded content data is read out and output to the system bus 120.

The mobile speech unit 102, audio input/output unit 107, melody generation unit 108, speaker/vocoder 109, and vibrator 110 are elements whose functions are similar to the known cellular phone functions. However, in the reservation video recording process according to the first embodiment of the present invention, one of the audio input/output unit 107, melody generation unit 108, speaker/vocoder 109, and vibrator 110 serves as a notification means for notifying the user of the reservation video recording disable condition. In the reservation video recording process according to the second embodiment of the present invention, one of the audio input/output unit 107, melody generation unit 108, speaker/vocoder 109, and vibrator 110 also serves as the notification means for notifying the user of the reservation video recording disable condition. In addition to this, in the reservation video recording disable condition, the mobile speech unit 102 serves as a communication means for requesting an external device (e.g., a video recording system at home, or a predetermined information service organization) to execute the reservation video recording process.

The tuner unit 111, demodulation unit 112, MPEG A/V decode unit 113, picture output unit 114, LCD monitor unit 115, external memory card interface 106, and memory card 118 are elements whose functions are similar to the known digital television broadcast reception functions. However, in the reservation video recording process according to the first and second embodiments, when the CPU/control unit 101 determines permission/inhibition of the reservation video recording process by this reception function, a signal is obtained as a parameter value (threshold value) for determining the reception condition of the reserved video recording program. The television broadcast signal received by an antenna (ANT) is supplied to the tuner unit 111. The tuner unit 111 obtains the television broadcast signal of the broadcast program (broadcasting station or broadcast channel) designated by the user, from the received television broadcast signal. The obtained television broadcast signal is converted into an IF (Intermediate Frequency) signal, and the converted signal is sent to the demodulation unit 112. The tuner unit 111 also outputs the received television broadcast signal reception power as the parameter value. This parameter value is obtained by the CPU/control unit 101, as the signal (threshold value) for determining permission/inhibition of the reservation video recording process.

The demodulation unit (OFDM demodulator) 112 generates a baseband picture signal and undemodulated audio signal from the received IF signal. The demodulation unit 112 also outputs a C/N (Carrier to Noise) ratio parameter and BER (Bit Error Rate) value parameter of the television broadcast signal. The CPU/control unit 101 obtains each of these parameter values as a signal for determining permission/inhibition of the reservation video recording process. Generally, in order to normally receive the digital television broadcast signal, it is important to transmit the picture signal and audio signal which are converted into digital signals, without any errors. In order to transmit the picture signal without any errors (pseudo error free), the BER value of an RS (Reed-Solomon) encoding/decoding output must be equal to or less than 1×10⁻¹¹. In order to obtain this value, the BER value of a Viterbi decoded output must be 2×10⁻⁴. In digital television broadcasting, the reception power and C/N are generally known as parameters for determining the reception condition. These values have different lower limits required for receiving the signals, in accordance with a modulation scheme and an encoding ratio. For example, in a Gaussian noise environment, the required C/N ratio is 4.9 dB when a QPSK encoding radio=½, and the required C/N ratio is 11.5 dB when a 16QAM encoding ratio=½. Also, the required electric field strength of the reception power must be 60 dB μV/m in a fixed reception condition. In these embodiments, the broadcast reception permission/inhibition determination process is executed by using the reception sensitivity parameter values as the threshold values.

Under the control of the CPU/control unit 101, the demodulation unit 112 sends the generated picture signal to the MPEG A/V decode unit 113, as the picture content data. After that, under the control of the CPU/control unit 101, the demodulation unit 112 sends the picture signal to the external memory card interface 106 through the bus. Under the control of the CPU/control unit 101, the demodulation unit 112 also sends the generated audio signal to the audio input/output unit 107 through the bus.

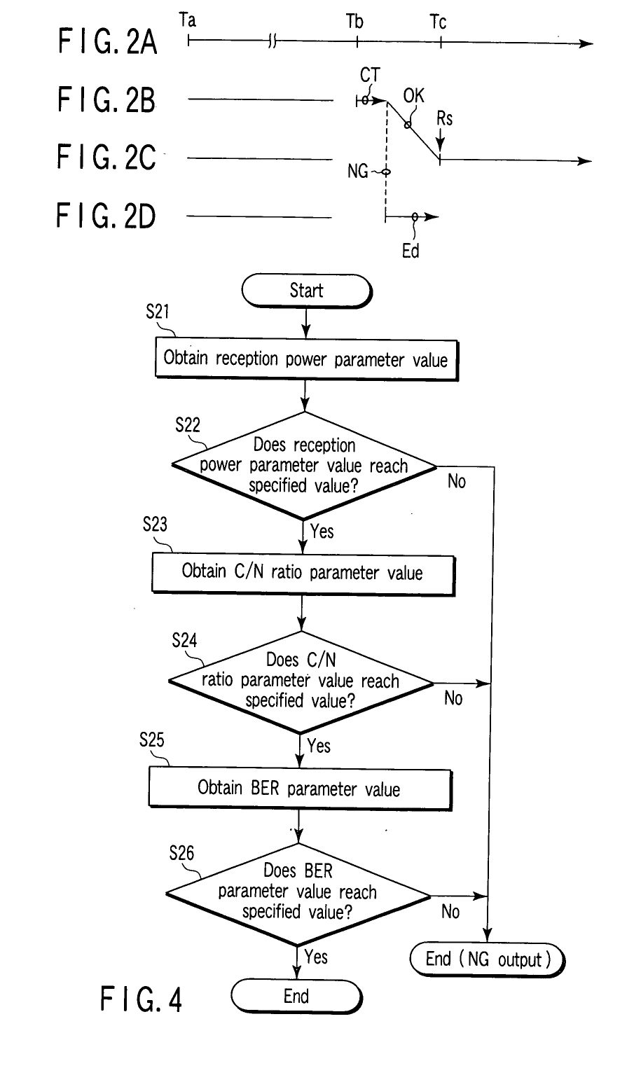

In the processing control of the reservation video recording process according to the first embodiment, the operation timing is shown in FIG. 2A, and the processing sequences are shown in FIGS. 3 and 4.

By the input operation of the operation unit 104, the reserved video recording broadcast program (broadcasting station or broadcast channel), its reservation video recording start time, and video recording permission/inhibition determination time are input. Upon designation of the reservation video recording, the CPU/control unit 101 stores these input data in the memory unit 103 while making them correspond to each other. The timer unit 105 is activated to start measuring (timer counting) the above-described reservation video recording start time and the video recording permission/inhibition determination time. Reference symbol Ta denotes this time measurement start timing in FIG. 2A.

When the timer unit 105 measures the video recording permission/inhibition determination time (step S11: YES), in order to determine the reception condition of the reserved program in the memory unit 103, the CPU/control unit 101 obtains the determination signal from the reception function unit (step S12) to execute the video recording permission/inhibition determination process (step S13).

In this video recording permission/inhibition determination process, as shown in the flowchart in FIG. 4, the reception power parameter value for the reservation video recording television broadcast signal is obtained from the tuner unit 111 (step S21), and it is determined whether the parameter value reaches a specified value (step S22). If the parameter value does not reach the specified value (step S22: NO), it is determined that the reserved video recording program cannot be normally received in the reservation video recording disable condition. Accordingly, the determination result is output.

Alternatively, if the reception power parameter value reaches the specified value (step S22: YES), the C/N ratio parameter value is obtained from the demodulation unit 112 (step S23), and it is determined whether the parameter value reaches the specified value (step S24). If the parameter value does not reach the specified value (step S24: NO), it is determined that the reserved video recording program cannot be normally received in the reservation video recording disable condition. Accordingly, the determination result is output.

If the C/N ratio parameter value reaches the specified value (step S24: YES), the BER parameter value is obtained from the demodulation unit 112 (step S25), and it is determined whether the parameter value reaches the specified value (step S26). If the parameter value does not reach the specified value (step S26: NO), it is determined that the reserved video recording program cannot be normally received in the reservation video recording disable condition. Accordingly, the determination result is output. If the parameter value reaches the specified value (step S26: YES), it is determined that the reserved video recording program can be normally received in the reservation video recording enable condition.

As described above, the video recording permission/inhibition condition of the reserved video recording program is determined in advance prior to video recording start. Reference symbol Tb denotes this determination processing timing in FIG. 2A, and reference symbol CT denotes the video recording permission/inhibition (OK/NG) determination process in FIG. 2B.

In the determination process as shown in FIG. 4, when it is determined that the reserved program is set in the reservation video recording enable condition, the determination block in step S14 shown in FIG. 3 becomes “OK”. Accordingly, when the timer unit 105 measures the reservation video recording start time, i.e., when the relationship (current time<reservation video recording start time) is not established (step S15: NO), the memory card 118 records (video-records) the picture signal and audio signal of the reserved program which is demodulated by the demodulation unit 112, as the reservation video recording content data through the external memory card interface 106. In this case, reference symbol Tc denotes the timing of measuring the reservation video recording start time in FIG. 2A, and reference symbol Rs denotes the recording (video recording) start timing in FIG. 2C.

In the determination process in step S14, when it is determined that the reserved program is set in the reservation video recording disable condition (step S14: NG), the user who has performed the reservation video recording process is notified of the condition by an alarm output (step S16). By this notification, before the reservation video recording start time, the user can take countermeasures for improving the reception condition until the video recording start time, or requesting another device to execute the video recording process. In this case, reference symbol Ed denotes the notification process in FIG. 2D.

When it is determined that the reception condition cannot be improved, the user can cancel the reservation video recording setting at this time, by the operation input from the operation unit 104.

After this notification, at the video recording start time, i.e., when the relationship (current time<reservation video recording start time) is not established (step S17: NO), the reservation video recording data stored in the memory unit 103 is erased, and the reservation video recording process set by the user becomes invalid (step S19).

Note that in steps S15 and S17, before the timer unit 105 measures the reservation video recording start time, i.e., when the relationship (current time<reservation video recording start time) is established (step S15: YES), the flow returns to step S12.

Note that the notification process in step S16 leads to a high notification effect, in combination with the audio input/output unit 107, melody generation unit 108, speaker/vocoder 109, vibrator 110, and LCD monitor unit 115 which are included in the elements of the cellular phone function.

For example, the melody generation unit 108 notifies the user of the reservation video recording disable condition by the melody alarm output unique to this condition notification. Hence, the user who has performed the reservation video recording process is clearly notified of the reservation video recording disable condition in distinction from another alarm notification.

When the LCD monitor unit 115 displays the information indicating the reservation video recording disable condition on a display, the user who has performed the reservation video recording process can easily recognize the reserved contents in the video recording disable condition, and a cause for the video recording disable condition.

The vibrator 110 can also notify only the user who has performed the reservation video recording process of the reservation video recording disable condition.

In a combination of these notification means, the user who has performed the reservation video recording process can be reliably notified of the reservation video recording disable condition, before the reservation video recording start time.

Therefore, when the user sets the reservation video recording, the user can be reliably notified of the reception condition of the broadcast program to be video-recorded, before the reservation video recording start time in advance. As a result, for example, the user can take countermeasures for improving the reception condition until the video recording start time, or requesting another device to execute the video recording process.

Next, the processing sequence of the reservation video recording in a portable electronic apparatus according to the second embodiment of the present invention will be described with reference to FIG. 5. In addition to a processing sequence according to the first embodiment shown in FIG. 3, in the processing sequence shown in FIG. 5, the user who has performed the reservation video recording process selects whether the reserved video recording broadcast program is requested to another device (as a substitute), when reaching the video recording start time after step S16, i.e., when the relationship (current time<reservation video recording start time) is not established (step S17: NO). If the user determines that the reserved broadcast program is to be requested to the substitute device (step S18: YES), a video recording mail is generated on the basis of the above-described reservation video recording data stored in the memory unit 103. The generated mail is transmitted from the mobile speech unit 102 (step S20).

With this mail transmission function, the reservation video recording process can be easily requested to another device without extending the time interval between the video recording permission/inhibition determination time for determining permission/inhibition of the reservation video recording process, and the reservation video recording start time.

Alternatively, in step S18, when the user determines that the video recording process is not requested to another device (step S18: NO), the flow advances to step S19.

The above-described first and second embodiments exemplify the known reception function of receiving and demodulating the digital television broadcast program by the tuner unit 111 and the demodulation unit 112. However, the tuner unit 111 and the demodulation unit 112 may have the reception function of receiving and demodulating the broadcast program for a mobile device. In this case, the reservation video recording function similar to that described in the first and second embodiments can also be implemented.

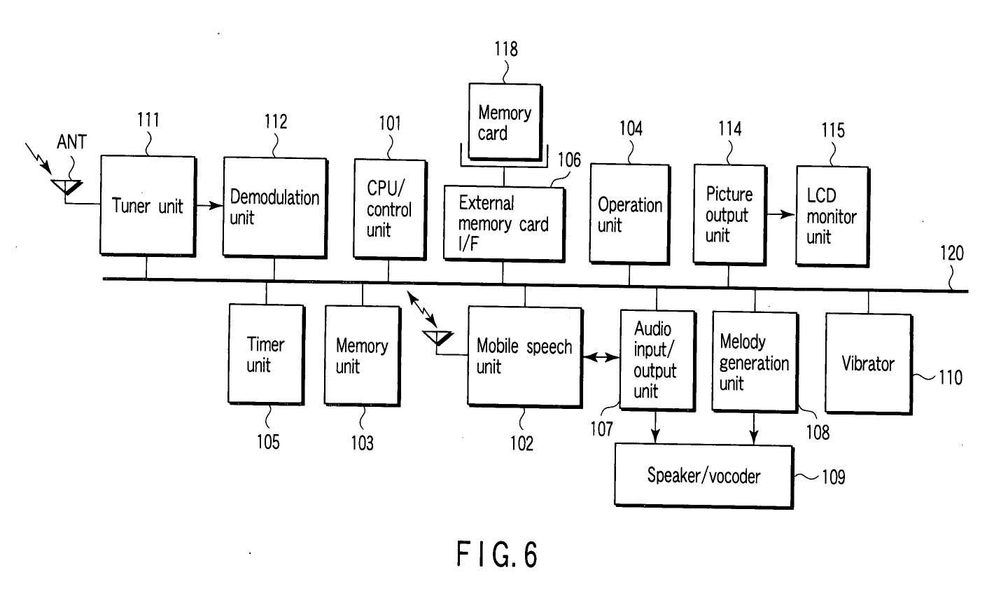

Next, the arrangement of a portable electronic apparatus according to the third embodiment of the present invention will be described with reference to FIG. 6. In the third embodiment, for example, the arrangement of a cellular phone set having a function of receiving and audio-recording (video-recording) a one-segment radio broadcast signal.

The portable electronic apparatus in the third embodiment is different from that in the first or second embodiment in that the memory card 118 records radio broadcast program contents, while the memory card 118 records (video-records) the television broadcast picture/audio contents in the first and second embodiments.

The portable electronic apparatus having the above-described function according to the third embodiment includes a CPU/control unit 101, mobile speech unit 102, memory unit 103, operation unit 104, timer unit 105, external memory card interface 106, tuner unit 111, demodulation unit 112, picture output unit 114, LCD monitor unit 115, audio input/output unit 107, melody generation unit 108, speaker/vocoder 109, vibrator 110, memory card 118, and the like, as in the first and second embodiments. Alternatively, an MPEG A/V decode unit 113 included in an electronic apparatus according to the first and second embodiments need not be provided. The above-described elements except the speaker/vocoder 109 and the memory card 118 are connected to each other through a system bus 120.

In the portable electronic apparatus according to the third embodiment, because of a processing control function of the reservation video recording process shown in FIGS. 3 to 5, when the program is reserved, the user can be notified of the reception condition of the broadcast program to be audio-recorded, before the reserved program start time. For example, the user can take countermeasures for improving the reception condition until the video recording start time, or requesting another device to execute the video recording process. As a result, a reliable reservation video recording function can be implemented.

When the user determines that the reception condition cannot be improved, the reservation video recording setting can also be canceled at the time of the operation input from the operation unit 104.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable electronic apparatus, comprising:
a reception unit configured to receive a broadcast program;
a recording unit configured to record contents of the broadcast program received by the reception unit;
a time setting unit configured to set a recording start time and a recording permission/inhibition determination time for recording the contents of the broadcast program received by the reception unit, on the recording unit;
a holding unit configured to hold time information indicating the recording start time and the recording permission/inhibition determination time set by the time setting unit;
a time measurement unit configured to measure time in accordance with the time information held by the holding unit; and
a recording control unit configured to check, when the time measurement unit measures the recording permission/inhibition determination time held by the holding unit, a reception condition of the reception unit, notify, when the reception unit is not set in a predetermined reception level condition in which the broadcast program is configured to be received, an external unit of the reception level condition, and record, when the reception unit is set in the predetermined reception level condition in which the broadcast program is configured to be received, the contents of the broadcast program received by the reception unit on the recording unit, after the time measurement unit measures the recording start time held by the holding unit.

2. An apparatus according to claim 1, wherein the reception unit comprises a first circuit configured to receive and demodulate a broadcast program for a mobile device, and the recording unit records the contents of the broadcast program demodulated by the first circuit.

3. An apparatus according to claim 2, wherein the reception unit comprises a second circuit configured to receive and demodulate a television broadcast program, and the recording unit records picture data and audio data included in the contents of the broadcast program demodulated by the second circuit.

4. An apparatus according to claim 2, wherein the reception unit comprises a third circuit configured to receive and demodulate a radio broadcast program, and the recording unit records audio data included in the contents of the broadcast program demodulated by the third circuit, or audio data and image data included in the contents.

5. An apparatus according to claim 2, which further comprises a station selecting unit, and
in which the reception unit receives a broadcast program selected by the station selecting unit.

6. An apparatus according to claim 1, wherein when setting the recording start time, the time setting unit sets the recording permission/inhibition determination time in accordance with the set time.

7. An apparatus according to claim 1, which further comprises an input unit configured to receive an input of the recording start time and the recording permission/inhibition determination time from a user, and
in which the time setting unit sets the recording start time and the recording permission/inhibition determination time in accordance with the input from the input unit.

8. An apparatus according to claim 1, which further comprises a notification unit, and
in which when the reception unit is not set in a predetermined reception level condition in which the broadcast program is configured to be received, the recording control unit causes the notification unit to notify a user who has set the recording start time of the condition.

9. An apparatus according to claim 8, wherein the recording control unit checks the reception condition of the reception unit while the recording unit records the contents of the broadcast program, and, when the reception level condition of the reception unit is changed from a broadcast program reception enable condition to a broadcast program reception disable condition, causes the notification unit to notify the user who has set the recording start time of the broadcast program reception disable condition.

10. An apparatus according to claim 8, wherein the notification unit performs the notification by using at least one of a sound output unit, a vibration unit, and a display unit.

11. An apparatus according to claim 1, which further comprises a cellular phone function unit, and
in which when the reception unit is not in a predetermined reception level condition in which the broadcast program is configured to be received, the recording control unit causes the cellular phone function to transmit control information for recording the contents of the broadcast program whose recording start time is set, in an external device, to the external device.

12. An apparatus according to claim 11, wherein the recording control unit checks the reception condition of the reception unit while the recording unit records the contents of the broadcast program, and, when the reception level condition of the reception unit is changed from a broadcast program reception enable condition to a broadcast program reception disable condition, causes the cellular phone function to transmits the control information to the external device.

13. An apparatus according to claim 1, wherein when the reception unit is continuously in a broadcast program reception disable level condition for a predetermined time upon changing from a broadcast program reception enable level condition, the recording control unit stops a recording operation of the recording unit.

14. An apparatus according to claim 1, wherein the recording control unit comprises a determination unit configured to determine whether the reception unit is set in a predetermined reception level condition in which the broadcast program is configured to be received, on the basis of at least one of a reception power of the broadcast program received by the reception unit, a C/N (Carrier to Noise) ratio, and a BER (Bit Error Rate) value.

15. An apparatus according to claim 1, wherein the recording unit comprises an external interface which records data included in the contents, on a card recording medium.

16. An apparatus according to claim 1, further comprising an output unit configured to play back and output the contents of the broadcast program received by the reception unit.

17. A recording control method of a portable electronic apparatus which comprises a reception unit configured to receive a broadcast program, and a recording unit configured to record contents of the broadcast program received by the reception unit, in accordance with reservation information, comprising:
checking a reception condition of the reception unit at a predetermined time prior to recording of the broadcast program in accordance with the reservation information;
when the reception unit is set in a predetermined reception level condition in which the broadcast program is configured not to be received, notifying an external device of the reception level condition; and
when the reception unit is set in a predetermined reception level condition in which the broadcast program is configured to be received, causing the recording unit to record the contents of the broadcast program received by the reception unit, from a time according to the reserved information.
